(19) United States
(12) Patent Application Publication
(10) Pub. No.: US 2023/0307713 A1
(43) Pub. Date: Sep. 28, 2023

(54) METHOD FOR MANUFACTURING SECONDARY BATTERY

(71) Applicant: MURATA MANUFACTURING CO., LTD., Kyoto (JP)

(72) Inventor: Ryosuke YAMAMOTO, Kyoto (JP)

(21) Appl. No.: 18/128,459

(22) Filed: Mar. 30, 2023

Related U.S. Application Data
(63) Continuation of application No. PCT/JP2021/041028, filed on Nov. 8, 2021.

(30) Foreign Application Priority Data
Nov. 24, 2020 (JP) 2020-194710

(51) Int. Cl. H01M 10/058; H01M 10/04

(52) U.S. Cl. CPC H01M 10/058; H01M 10/049

(57) ABSTRACT

A method for manufacturing a secondary battery, the method including: installing an electrode assembly inside a cup-shaped exterior member; providing a lid-shaped exterior member such that the lid-shaped exterior member covers an opening of the cup-shaped exterior member; and forming a welded portion by applying a laser beam to a facing portion where the cup-shaped exterior member and the lid-shaped exterior member face each other, in which the facing portion is formed by positioning an end face of an end part of one of the cup-shaped exterior member and the lid-shaped exterior member on an end face of an end part of the other exterior member, and each of the end faces is in a non-stepped form.

### CROSS REFERENCE TO RELATED APPLICATIONS

The present application is a continuation of PCT Pat. application no. PCT/JP2021/041028, filed on Nov. 8, 2021, which claims priority to Japanese Pat. application no. JP 2020-194710, filed on Nov. 24, 2020, the entire contents of which are herein incorporated by reference.

### BACKGROUND

The present application relates to a method for manufacturing a secondary battery. More specifically, the present application relates to a method for manufacturing a secondary battery including an electrode assembly including a positive electrode, a negative electrode, and a separator.

Secondary batteries are so-called storage batteries, and therefore can be repeatedly charged and discharged and are used for various applications. For example, the secondary battery has been used in mobile devices such as mobile phones, smart phones, and laptop computers.

### SUMMARY

The present application relates to a method for manufacturing a secondary battery.

The present inventor of the present application has noticed that the conventional secondary batteries have problems to be overcome, and has found a need to take measures therefor. For example, the present inventor has found that there is a following problem (see FIGS. 12A and 12B).

The secondary battery includes an electrode assembly 10′ including a positive electrode, a negative electrode, and a separator therebetween, and an exterior body 50′ enclosing the electrode assembly 10′. The exterior body of the secondary battery includes, for example, two exterior members (a cup-shaped member and a lid-shaped member) connected to each other by a welded portion 20′. The welded portion 20′ can be formed by, for example, making a stepped portion 55′ provided at the end part of the cup-shaped exterior member 51′ face a stepped portion 54′ provided at the end part of the lid-shaped exterior member 52′ to be fitted thereto, and irradiating the facing portion 53′ with a laser beam L′ .

In this regard, it is preferable that the facing portion 53′ is sealed without containing a gap from the viewpoint of improving the sealing property at the time of irradiating the electrode assembly 10′ with the laser beam L′ and from the viewpoint of preventing spatters 90′ that may be generated. However, in the facing portions between the substantially vertical planes 54a′ and 55a′ and between the substantially vertical planes 54c′ and 55c′, which are components of the stepped portions 54′ and 55′ of the cup-shaped exterior member 51′ and the lid-shaped exterior member 52′, a gap G′ is more likely to be generated due to the form of the facing portions than the facing portion between the substantially horizontal planes 54b′ and 55b′, which are components of the stepped portions 54′ and 55′. Therefore, it is necessary to take measures such as highly accurate positioning adjustment so that no gap is generated in the facing portions between the substantially vertical planes, and it is not preferable from the viewpoint of production efficiency.

In an embodiment, the present relates to providing a method for manufacturing a secondary battery by which the sealing property of a facing portion of a cup-shaped exterior member and a lid-shaped exterior member can conveniently be secures.

In an embodiment, a method for manufacturing a secondary battery is provided, the method including:
a step of installing an electrode assembly inside a cup-shaped exterior member;
a step of providing a lid-shaped exterior member such that the lid-shaped exterior member covers an opening of the cup-shaped exterior member; and
a step of forming a welded portion by applying a laser beam to a facing portion where the cup-shaped exterior member and the lid-shaped exterior member face each other,
in which the facing portion is formed by positioning an end face of an end part of one of the cup-shaped exterior member and the lid-shaped exterior member on an end face of an end part of the other exterior member, and each of the end faces is in a non-stepped form.

Using the method for manufacturing a secondary battery according to an embodiment of the present application, it is possible to conveniently secure the sealing property of a facing portion of a cup-shaped exterior member and a lid-shaped exterior member.

### BRIEF DESCRIPTION OF THE FIGURES

FIG. 1A is a schematic sectional view illustrating a step of installing an electrode assembly inside a cup-shaped exterior member in the method for manufacturing a secondary battery according to an embodiment of the present application.

FIG. 1B is a schematic sectional view illustrating in a step of forming a welded portion by applying a laser beam in the method for manufacturing a secondary battery according to an embodiment of the present application.

FIG. 1C is a schematic sectional view illustrating a secondary battery obtained in accordance with a method for manufacturing a secondary battery according to an embodiment of the present application.

FIG. 2 is an enlarged schematic sectional view of FIG. 1B.

FIG. 3 is a schematic perspective view illustrating a specific configuration of FIG. 1C.

FIG. 4 is a schematic sectional view illustrating a specific configuration of FIG. 1C.

FIG. 5 is a schematic sectional view illustrating a step of forming a welded portion using a lid-shaped exterior member having a side face in an inclined form at an end part and a cup-shaped exterior member having an end face in an inclined form at an end part.

FIG. 6 is a schematic sectional view illustrating a step of forming a welded portion using a lid-shaped exterior member having a side face in an inclined form at an end part and a cup-shaped exterior member having a side face in an inclined form at an end part.

FIG. 7 is a schematic perspective view illustrating a secondary battery obtained through the step of forming a welded portion illustrated in FIG. 6.

FIG. 8A is a schematic sectional view illustrating a step of installing an electrode assembly inside a cup-shaped exterior member in a method for manufacturing a secondary battery according to another embodiment of the present application.

FIG. 8B is a schematic sectional view illustrating a step of drawing the end part of the cup-shaped exterior member in a method for manufacturing a secondary battery according to another embodiment of the present application.

FIG. 8C is a schematic sectional view illustrating a step of forming a welded portion by the application of a laser beam in a method for manufacturing a secondary battery according to another embodiment of the present application.

FIG. 9 is a schematic sectional view illustrating a step of forming a welded portion by the application of a laser beam in accordance with a method for manufacturing a secondary battery according to another embodiment of the present application.

FIG. 10 is a schematic sectional view illustrating a step of forming a welded portion by the application of a laser beam in accordance with a method for manufacturing a secondary battery according to another embodiment of the present application.

FIG. 11A is a sectional view schematically illustrating an electrode configuration layer having a planar stacked structure.

FIG. 11B is a sectional view schematically illustrating an electrode configuration layer having a wound structure.

FIG. 12A is a schematic sectional view relating to a laser beam application mode for a stepped facing portion between an end part of a cup-shaped exterior member and an end part of a lid-shaped exterior member (conventional technology).

FIG. 12B is a schematic sectional view relating to a mode of forming a welded portion through the laser beam application mode of FIG. 12A (conventional technology).

### DETAILED DESCRIPTION

A method for manufacturing a secondary battery according to an embodiment of the present application will be described below in more detail. Although the description will be made with reference to the drawings as necessary, various elements in the drawings are merely schematically and exemplarily shown for understanding of the present disclosure, and the appearance and the dimensional ratio and the like can be different from those of an actual secondary battery.

The term “sectional view” directly or indirectly described in the present description is based on a virtual cross section obtained by cutting the secondary battery along the height direction. The “vertical direction” and “horizontal direction” used directly or indirectly in the present description respectively correspond to the vertical direction and horizontal direction in the drawings. Unless otherwise specified, the same reference signs or symbols denote the same members or sites, or the same semantic contents. In a suitable aspect, when the stacking direction of an electrode assembly can correspond to the vertical direction, it can be understood that a vertical downward direction (that is, a direction in which gravity acts) corresponds to the term “downward direction” and the opposite direction corresponds to the term “upward direction”.

The term “secondary battery” as used in the present specification refers to a battery that can be repeatedly charged and discharged. Accordingly, the secondary battery according to the present application is not excessively limited by its name, and for example, an electric storage device and the like can also be included in the subject of the present application.

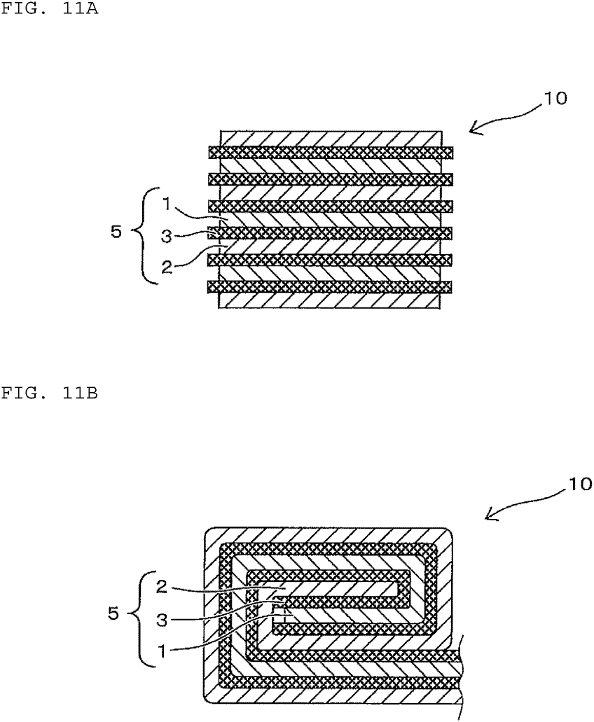

The secondary battery according to an embodiment of the present application includes an electrode assembly formed by stacking electrode configuration layers including a positive electrode, a negative electrode, and a separator. FIGS. 11A and 11B illustrate an electrode assembly 10. As illustrated in FIG. 11A and FIG. 11B, a positive electrode 1 and a negative electrode 2 are stacked with a separator 3 interposed therebetween to form an electrode configuration layer 5, and at least one or more of the electrode configuration layers 5 are stacked to configure the electrode assembly. FIG. 11A illustrates a planar stacked structure in which the electrode configuration layers 5 are stacked in a planar shape without being wound. Meanwhile, FIG. 11B illustrates a wound stacked structure in which the electrode configuration layer 5 is wound in a wound shape. That is, FIG. 11B illustrates a wound structure in which an electrode configuration layer including a positive electrode, a negative electrode, and a separator disposed between the positive electrode and the negative electrode is wound in a roll shape. For the secondary battery, such an electrode assembly is enclosed together with an electrolyte (for example, a non-aqueous electrolyte) in an exterior body. The structure of the electrode assembly is not necessarily limited to the planar stacked structure or the wound structure. For example, the electrode assembly may have a so-called stack-and-folding type structure in which a positive electrode, a separator, and a negative electrode are stacked on a long film and then folded.

The positive electrode is composed of at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for the plurality of positive electrodes in the electrode assembly, for each of the electrodes, the positive electrode material layer may be provided on both sides of the positive electrode current collector, or may be provided only on one side of the positive electrode current collector.

The negative electrode is composed of at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for the plurality of negative electrodes in the electrode assembly, for each of the electrodes, the negative electrode material layer may be provided on both sides of the negative electrode current collector, or may be provided only on one surface of the negative electrode current collector.

The electrode active material contained in the positive electrode and the negative electrode, that is, the positive electrode active material and the negative electrode active material are substances directly involved in the transfer of electrons in the secondary battery, and are main substances of the positive and negative electrodes which are responsible for charging and discharging, that is, a battery reaction. More specifically, ions are brought in the electrolyte due to the “positive electrode active material contained in the positive electrode material layer” and the “negative electrode active material contained in the negative electrode material layer”, and such ions move between the positive electrode and the negative electrode to transfer electrons, thereby performing charging and discharging. The positive electrode material layer and the negative electrode material layer may be layers particularly capable of occluding and releasing lithium ions. That is, the secondary battery according to the present application may be a non-aqueous electrolyte secondary battery in which lithium ions move between a positive electrode and a negative electrode through a non-aqueous electrolyte to charge and discharge a battery. When lithium ions are involved in charging and discharging, the secondary battery according to the present application corresponds to a so-called “lithium ion battery”, and the positive electrode and the negative electrode include a layer capable of occluding and releasing lithium ions.

When the positive electrode active material of the positive electrode material layer is composed of, for example, a granular material, a binder may be included in the positive electrode material layer for more sufficient contact between the particles and shape retention. Furthermore, a conductive auxiliary agent may be included in the positive electrode material layer to facilitate the transfer of electrons promoting a battery reaction. Similarly, when the negative electrode active material of the negative electrode material layer is composed of, for example, a granular material, a binder may be contained for more sufficient contact between granules and shape retention, and a conductive auxiliary agent may be contained in the negative electrode material layer in order to facilitate electron transfer promoting the battery reaction. Since the positive electrode material layer and the negative electrode material layer contain a plurality of components in this manner, the positive electrode material layer and the negative electrode material layer may also be referred to as “positive electrode mixture layer” and “negative electrode mixture layer”, respectively.

The positive electrode active material may be a material that contributes to occlusion and release of lithium ions. From such a viewpoint, the positive electrode active material may be, for example, a lithium-containing composite oxide. More specifically, the positive electrode active material may be a lithium-transition metal composite oxide containing lithium and at least one transition metal selected from a group consisting of cobalt, nickel, manganese, and iron. More specifically, in the positive electrode material layer of the secondary battery according, such a lithium-transition metal composite oxide is preferably included as a positive electrode active material. For example, the positive electrode active material may be lithium cobaltate, lithium nickelate, lithium manganate, lithium iron phosphate, or a material obtained by replacing a part of the transition metals with another metal. Such a positive electrode active material may be included as a single species, or two or more species may be included in combination.

The binder which can be contained in the positive electrode material layer is not particularly limited, but examples thereof include at least one selected from the group consisting of polyvinylidene fluoride, a vinylidene fluoride-hexafluoropropylene copolymer, a vinylidene fluoride-tetrafluoroethylene copolymer, and polytetrafluoroethylene and the like. The conductive auxiliary agent that can be contained in the positive electrode material layer is not particularly limited, but examples thereof can include at least one selected from carbon blacks such as thermal black, furnace black, channel black, ketjen black, and acetylene black, carbon fibers such as graphite, carbon nanotube, and vapor-grown carbon fiber, metal powders such as copper, nickel, aluminum, and silver, and polyphenylene derivatives.

The thickness dimension of the positive electrode material layer is not particularly limited, and may be 1 µm or more and 300 µm or less, and is, for example, 5 µm or more and 200 µm or less. The thickness dimension of the positive electrode material layer is a thickness inside the secondary battery, and the average value of measured values at random 10 points may be employed.

The negative electrode active material may be a material that contributes to occlusion and release of lithium ions. From such a viewpoint, the negative electrode active material may be, for example, various carbon materials, oxides, and/or lithium alloys.

Examples of various carbon materials of the negative electrode active material can include graphite (natural graphite and/or artificial graphite), hard carbon, soft carbon, and/or diamond-like carbon. Particularly, graphite has high electron conductivity and superior adhesion to the negative electrode current collector. Examples of the oxide of the negative electrode active material include at least one selected from the group consisting of silicon oxide, tin oxide, indium oxide, zinc oxide, and lithium oxide and the like. The lithium alloy of the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, and La. Such an oxide may be amorphous as a structural form thereof. This is because deterioration due to nonuniformity such as grain boundaries or defects is less likely to be caused.

The binder which can be contained in the negative electrode material layer is not particularly limited, but examples thereof include at least one kind selected from the group consisting of styrene-butadiene rubber, polyacrylic acid, polyvinylidene fluoride, polyimide-based resin, and polyamideimide-based resin. The conductive auxiliary agent which can be contained in the negative electrode material layer is not particularly limited, but examples thereof include at least one selected from the group consisting of carbon black such as thermal black, furnace black, channel black, ketjen black, and acetylene black; carbon fibers such as graphite, carbon nanotube, and vapor-grown carbon fiber; metal powders such as copper, nickel, aluminum, and silver; polyphenylene derivatives, and the like. The negative electrode material layer may contain a component caused by a thickener component (for example, carboxymethyl cellulose) used at the time of manufacturing the battery.

A thickness dimension of the negative electrode material layer is not particularly limited, but may be 1 µm or more and 300 µm or less, and is, for example, 5 µm or more and 200 µm or less. The thickness dimension of the negative electrode material layer is a thickness inside the secondary battery, and the average value of measured values at random 10 points may be employed.

The positive electrode current collector and the negative electrode current collector used for the positive electrode and the negative electrode are members configured to contribute to collecting and supplying electrons generated in the electrode active material due to the battery reaction. Such an electrode current collector may be a sheet-like metal member. Further, the electrode current collector may have a porous or perforated form. For example, the current collector may be a metal foil, a punching metal, a net or an expanded metal, or the like. The positive electrode current collector used for the positive electrode is preferably made of a metal foil containing at least one selected from the group consisting of aluminum, stainless steel, and nickel, and may be, for example, an aluminum foil. In contrast, the negative electrode current collector used for the negative electrode is preferably made of a metal foil containing at least one selected from the group consisting of copper, stainless steel, and nickel, and may be, for example, a copper foil.

The thickness dimension of each of the positive electrode current collector and the negative electrode current collector is not particularly limited, and may be 1 µm or more and 100 µm or less, and is, for example, 10 µm or more and 70 µm or less. The thickness dimension of each of the positive electrode current collector and the negative electrode current collector is a thickness inside the secondary battery, and the average value of measured values at random 10 points may be employed.

The separator used for the positive electrode and the negative electrode serves as a member that is provided from the viewpoints of preventing a short circuit due to contact between the positive and negative electrodes, holding the electrolyte, and the like. In other words, it can be said that the separator is a member configured to allow ions to pass while preventing electronic contact between the positive electrode and the negative electrode. For example, the separator is a porous or microporous insulating member, and has a membrane form due to its small thickness. As a mere example, a microporous membrane made of polyolefin may be used as the separator. In this regard, the microporous membrane used as the separator may contain, for example, only polyethylene (PE) or only polypropylene (PP) as polyolefin. Furthermore, the separator may be a laminated body formed of a “microporous membrane made of PE” and a “microporous membrane made of PP”. A surface of the separator may be covered with an inorganic particle coating layer and/or an adhesive layer. The surface of the separator may have adhesion. Further, in the present application, the separator is not to be particularly limited by its name, and may be solid electrolytes, gel electrolytes, and/or insulating inorganic particles that have a similar function.

The thickness dimension of the separator is not particularly limited, and may be 1 µm or more and 100 µm or less, and is, for example, 2 µm or more and 20 µm or less. The thickness dimension of the separator is a thickness inside the secondary battery (particularly, the thickness between the positive electrode and the negative electrode), and the average value of measured values at random 10 points may be employed.

In the secondary battery according to an embodiment, an electrode assembly including an electrode configuration layer including a positive electrode, a negative electrode, and a separator may be enclosed in an exterior body together with an electrolyte. The electrolyte may be a “non-aqueous” electrolyte containing an organic electrolyte, an organic solvent, and the like, or may be an “aqueous” electrolyte containing water. When the positive electrode and the negative electrode include a layer capable of occluding and releasing lithium ions, the electrolyte is preferably a “non-aqueous” electrolyte such as an organic electrolyte or an organic solvent. More specifically, the electrolyte preferably serves as a non-aqueous electrolyte. In the electrolyte, metal ions released from the electrode (the positive electrode and/or the negative electrode) are present, and therefore the electrolyte can assist the movement of metal ions in the battery reaction. It is to be noted that the electrolyte may have a form such as a liquid form or a gel form.

The non-aqueous electrolyte is an electrolyte including a solvent and a solute. The solvent may be an organic solvent. The specific organic solvent of the non-aqueous electrolyte may contain at least carbonate. The carbonate may be a cyclic carbonate and/or a chain carbonate. Although not particularly limited, an example of the cyclic carbonate can include at least one selected from a group consisting of propylene carbonate (PC), ethylene carbonate (EC), butylene carbonate (BC), and vinylene carbonate (VC). Examples of the chain carbonate include at least one selected from the group consisting of a dimethyl carbonate (DMC), a diethyl carbonate (DEC), an ethyl methyl carbonate (EMC), and a dipropyl carbonate (DPC). By way of an example only, a combination of a cyclic carbonate and a chain carbonate may be used as the non-aqueous electrolyte, and for example, a mixture of an ethylene carbonate and a diethyl carbonate may be used. As a specific solute for the non-aqueous electrolyte, for example, Li salts such as LiPF₆ and/or LiBF₄ may be used.

The exterior body of the secondary battery is a member enclosing an electrode assembly formed by stacking electrode configuration layers including a positive electrode, a negative electrode, and a separator. The exterior body may be composed of a metal such as stainless steel (SUS) and/or aluminum. The term “stainless steel” in the present specification refers to, for example, stainless steel defined in “JIS G 0203 Glossary of terms used in iron and steel”, and may be chromium or alloy steel containing chromium and nickel.

Hereinafter, characteristic parts of the present disclosure will be described in further detail according to an embodiment.

The present inventor of the present application has studied a solution for conveniently securing the sealing property of the facing portion of the cup-shaped exterior member and the lid-shaped exterior member. As a result, the present inventor has devised a method for manufacturing a secondary battery according to an embodiment of the present disclosure.

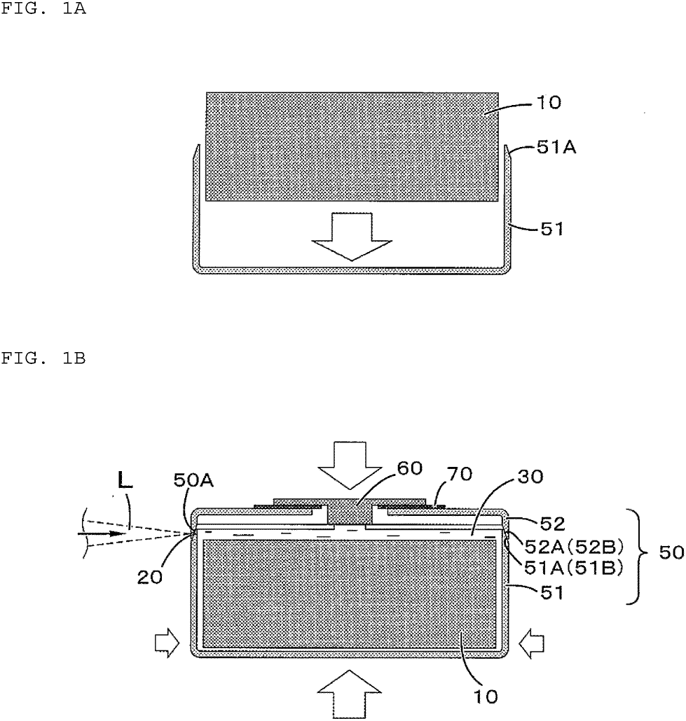

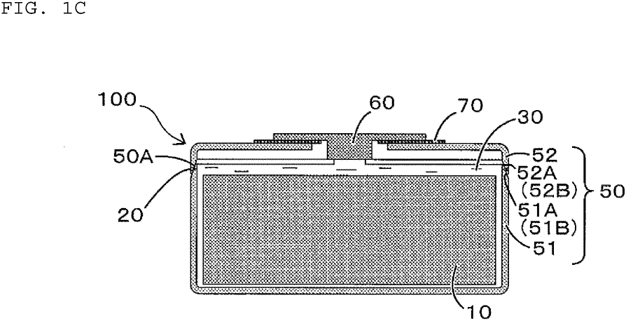

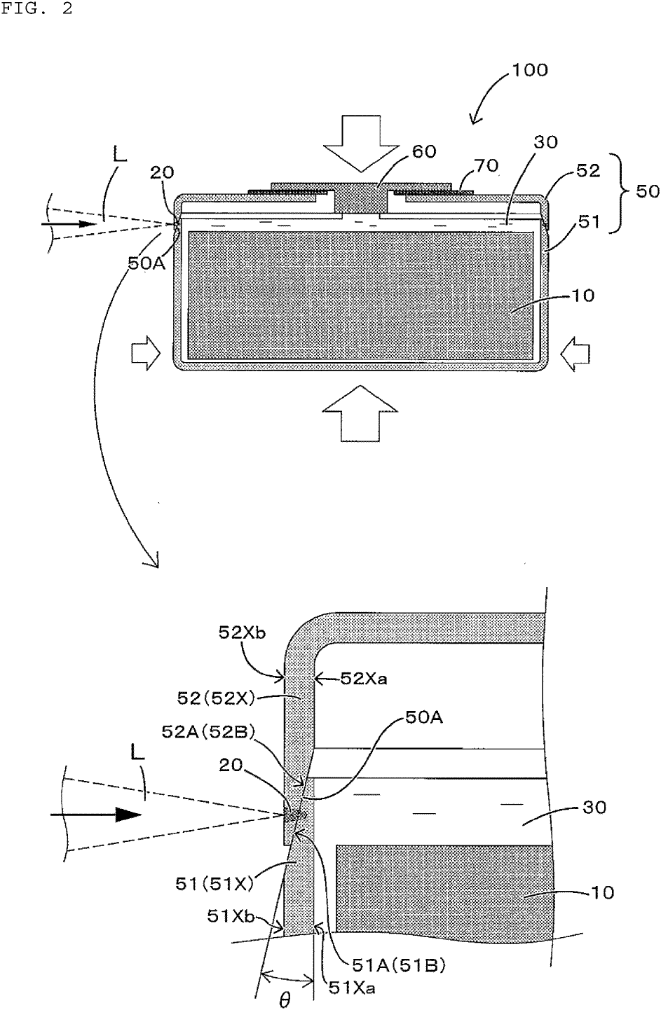

FIG. 1A is a schematic sectional view illustrating a step of installing an electrode assembly inside a cup-shaped exterior member in the method for manufacturing a secondary battery according to an embodiment. FIG. 1B is a schematic sectional view illustrating in a step of forming a welded portion by applying a laser beam in the method for manufacturing a secondary battery according to an embodiment. FIG. 1C is a schematic sectional view illustrating a secondary battery obtained in accordance with the method for manufacturing a secondary battery according to an embodiment. FIG. 2 is an enlarged schematic sectional view of FIG. 1B.

The “cup-shaped exterior member” means a member that includes a side wall or a side face portion corresponding to a body portion and a main face (in a typical mode, for example, a bottom portion) continuous with the side wall or the side face portion, and in which a hollow portion is formed. The “lid-shaped exterior member” means a member (preferably, a member covering the cup-shaped member so as to extend over the side wall of the cup-shaped member) provided so as to cover the cup-shaped member.

Hereinafter, a method for manufacturing a secondary battery according to an embodiment of the present application will be described in further detail including with reference to drawings.

The method for manufacturing a secondary battery according to an embodiment includes:
(i) A step of installing an electrode assembly 10 inside a cup-shaped exterior member 51 (see FIG. 1A);
(ii) A step of providing a lid-shaped exterior member 52 such that this member covers an opening of the cup-shaped exterior member 51 with the cup-shaped exterior member 51 having been filled with an electrolytic solution 30; and
(iii) A step of applying a laser beam L to a portion 50A where the cup-shaped exterior member 51 and the lid-shaped exterior member 52 face each other to form a welded portion 20 (see FIG. 1B and FIG. 1C).

The method for manufacturing a secondary battery according to an embodiment is characterized in the steps (ii) and (iii) among the above steps. Specifically, before forming a welded portion 20 by applying a laser beam L, a facing portion 50A is formed by positioning an end face of an end part of one of the cup-shaped exterior member 51 and the lid-shaped exterior member 52 on an end face of an end part of the other exterior member, and each of the end faces is in a non-stepped form (see FIGS. 1B, 1C, and 2). That is, the facing portion 50A is formed by positioning the end face with a non-stepped form of the end part of one of the cup-shaped exterior member 51 and the lid-shaped exterior member 52 on the end face in a non-stepped form of the end part of the other exterior member. As one example, an end face 51A in a non-stepped form of an end part of the lid-shaped exterior member 51 is positioned on an end face 52A in a non-stepped form of an end part of the cup-shaped exterior member 52 to form a facing portion 50A.

The term “end face” as used herein means a face constituting at least a part of an end part of each exterior member forming a facing portion (namely, a boundary portion) of the cup-shaped exterior member 51 and the lid-shaped exterior member 52. The “end face in a non-stepped form” referred to herein means an end face that does not have a stepped form (namely, a form composed of two faces differing in height and a face connecting the end parts of the two faces), and examples thereof include an inclined shape, a horizontal plane shape, a curved surface shape, a tapered shape, and a wavy shape.

In an embodiment, it is important to position the end face of one exterior member on the end face of the other exterior member. In order to position (namely, place) one end face on the other end face, it is necessary that each end face is not a face extending in the gravity direction. In view of this point, each end face can be said to be a face extending in a direction different from the gravity direction (namely, the non-vertical direction or the non-gravity direction). The end faces of the exterior members may have shapes that are paired with each other. For example, when the end face of the cup-shaped exterior member 51 is inclined, the end face of the lid-shaped exterior member 52 may be inclined. The end faces of the exterior members may be faces extending in the same direction. For example, when the end face of the cup-shaped exterior member 51 is a face extending in an inclined manner, the end face of the lid-shaped exterior member 52 may be a face extending in the same direction as the direction in which the end face of the cup-shaped exterior member 51 extends. Taking such a mode makes it easy to position the end face of one exterior member on the end face of the other exterior member.

In accordance with the above feature, in a state where the facing portion 50A is formed, a force such as gravity can be applied downward from the end face 52A, which is a component of the end part of the lid-shaped exterior member 52, to the end face 51A, which is a component of the end part of the cup-shaped exterior member 51. As a result, it is possible to inhibit generation of a gap between the end faces 51A and 52A, which are components of the end parts of both the exterior members, and as a result, it is possible to bring the end faces 51A and 52A into facing contact with each other. Therefore, in accordance with an embodiment, it is possible to conveniently secure the sealing property of the facing portion 50A of the cup-shaped exterior member 51 and the lid-shaped exterior member 52.

When the sealing property of the facing portion 50A is conveniently secured, the following effects can be exhibited.

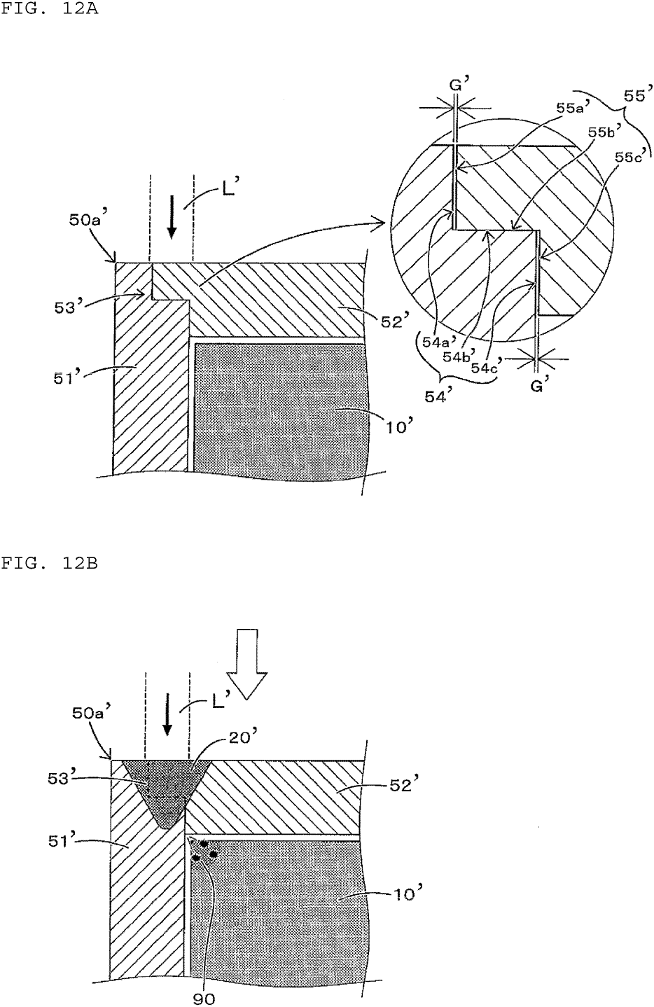

Conventionally, in the manufacture of the exterior body 50′ of the secondary battery, it has been necessary to take a further measure for preventing generation of a gap in a facing portion between the substantially horizontal planes 54b′ and 55b′ of the stepped portions 54′ and 55′ provided at the end parts of the cup-shaped exterior member 51′ and the lid-shaped exterior member 52′ (see FIGS. 12A and 12B). In order to cope with this, for example, highly accurate positioning adjustment and production of a cup-shaped exterior member 51′ and a lid-shaped exterior member 52′ with high dimensional accuracy are required so that both the stepped portions 54′ and 55′ can come into contact with each other without forming a gap. Therefore, it takes time and cost to manufacture equipment for realizing highly accurate positioning adjustment, and furthermore, it takes time and cost to manufacture a mold itself for obtaining exterior members with high dimensional accuracy.

In an embodiment, since it is possible to inhibit generation of a gap between the end faces 51A and 52A, which are components of the end parts of both the exterior members, it is not required to perform highly accurate positioning adjustment and manufacture cup-shaped and lid-shaped exterior members having high dimensional accuracy as in the conventional mode. Therefore, it is not necessary to spend time and cost to manufacture equipment for realizing highly accurate positioning adjustment, and furthermore, it is not necessary to spend time and cost to manufacture a mold itself for obtaining exterior members with high dimensional accuracy.

In addition, conventionally, when a gap is generated in the facing portion, it is required to increase the output of the laser beam L′ and apply the laser beam to a wide range in order to fill the gap. As a result, the irradiation thermal energy of the laser beam L′ is likely to propagate to the electrode assembly 10′, and the possibility of causing thermal damage increases (see FIGS. 12A and 12B). In contrast, in an embodiment, since it is possible to inhibit generation of a gap between the end faces 51A and 52A at the end parts of both the exterior members, it is possible to reduce the output of the laser beam L and apply the laser beam to a narrow range as compared with the prior art. As a result, it is possible to suitably inhibit propagation of the irradiation heat energy of the laser beam L to the electrode assembly 10, and it is possible to suitably reduce the thermal damage to the electrode assembly 10 and the intrusion of a spatter that may occur at the time of forming the welded portion 20.

When the lid-shaped exterior member 52 is provided such that this member covers the opening of the cup-shaped exterior member 51, a force may be applied along the vertical direction (for example, the gravity direction) to clamp the main faces of the cup-shaped and lid-shaped exterior members 51 and 52. Specifically, with the end face 52A of the lid-shaped exterior member 52 being placed on the end face 51A of the cup-shaped exterior member 51, the force may be applied along the vertical direction (for example, the gravity direction) to clamp the main faces of the exterior members. The force to clamp the main faces is a force to press the end faces 51A and 52A of the exterior members against each other. Therefore, the end faces 51A and 52A can be brought into closer contact with each other than a case where only an action such as gravity acts. By taking such a mode, it is possible to further inhibit generation of a gap between the end faces 51A and 52A of both the exterior members.

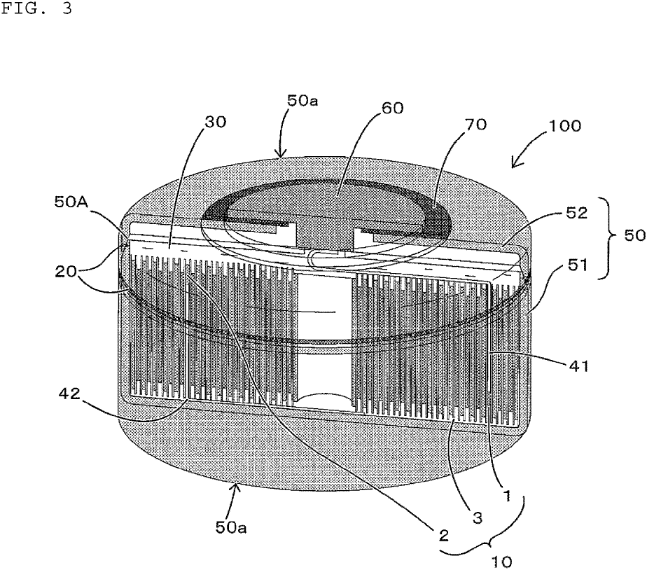

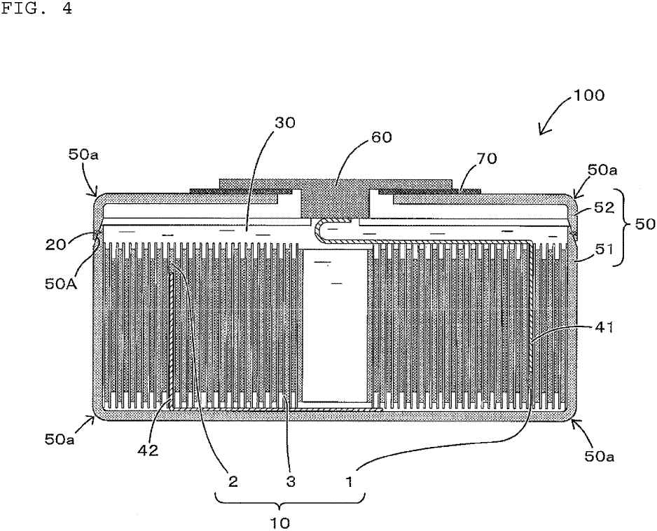

Hereinafter, a secondary battery obtained by the method for manufacturing a secondary battery according to an embodiment including the above-described step (iii) is described with reference to FIGS. 3 and 4. FIG. 3 is a schematic perspective view showing the specific configuration of a secondary battery according to an embodiment o. FIG. 4 is a schematic sectional view showing the specific configuration of a secondary battery according to an embodiment.

FIG. 3 is a schematic perspective view illustrating a specific configuration of FIG. 1C. FIG. 4 is a schematic sectional view illustrating a specific configuration of FIG. 1C. As illustrated in FIGS. 3 and 4, the secondary battery 100 obtained by the above-described manufacturing method according to an embodiment includes an electrode assembly 10 and an exterior body 50 that houses the electrode assembly 10.

The exterior body 50 includes a cup-shaped exterior member 51 and a lid-shaped exterior member 52 connected to each other by a welded portion 20. The welded portion 20 is formed to link an end part of the cup-shaped exterior member 51 and an end part of the lid-shaped exterior member 52. In this regard, in a conventional secondary battery 100′, as illustrated in FIG. 12A, a laser beam L′ is applied such that both a substantially vertical plane and a substantially horizontal plane, which are components of the stepped portions 54′ and 55′ of the cup-shaped exterior member 51′ and the lid-shaped exterior member 52′ before welding, are melted. For this reason, the size of the welded portion 20′ (FIG. 12B) obtained after the application of the laser beam is relatively large. In contrast, as described above, in an embodiment of the present application, it is possible to form a welded portion 20 by controlling the output of the laser beam L and applying the laser beam L to a narrow range during the manufacture. As a result, the size of the welded portion 20 can be reduced as compared with the welded portion 20′ of the conventional secondary attery 100′.

The fact that the size of the welded portion 20 is smaller means that thermal damage to the electrode assembly 10 during the formation of the welded portion 20 and the intrusion of spatters that may occur during the formation of the welded portion 20 are suitably reduced. Accordingly, as compared with the conventional secondary battery 100′, the battery characteristics of the secondary battery 100 obtained can be further stabilized.

Furthermore, the size of the welded portion 20 of the secondary battery obtained by the manufacturing method for the present application is smaller than that of the welded portion 20′ of the conventional secondary battery 100′. For this reason, as illustrated in FIGS. 3 and 4, facing contact regions (cuts) between the end face 52A, which is a component of the end part of the lid-shaped exterior member 52, and the end face 51A, which is a component of the end part of the cup-shaped exterior member 51, may remain on both sides of the welded portion 20. Also in this respect, the secondary battery 100 obtained has the above-described appearance characteristics.

The secondary battery 100 obtained may be a coin-type secondary battery. The coin-type secondary battery typically has a substantially circular shape in plan view. The coin-type secondary battery does not need to be substantially circular in plan view, and may have a deformed shape including a straight portion in a part thereof (for example, a D shape in plan view). When the secondary battery has a substantially circular shape in plan view, the electrode assembly 10 and/or the exterior body 50 including the electrode assembly may also have a substantially circular shape in plan view. The “substantially circular shape (substantially circular)” as used herein is not limited to a perfect circular shape (that is, simply “circle” or “perfect circle”). The curvature of the arc of the substantially circular shape may be locally different, and the substantially circular shape may be, for example, a shape derived from a circle or a perfect circle such as an ellipse. The size of the coin-type secondary battery is typically small, and the thickness thereof is smaller than the diameter or width of the coin-type secondary battery. The “coin-type” secondary battery is merely referred to as “coin-type” by those skilled in the art because the appearance described above is an appearance like “coin-type” appearance. Therefore, the coin-type secondary battery may be variously renamed, depending on the appearance, a button battery, a micro battery, or a tubular battery, an oblate battery, a flat battery, a leveled battery, a cylindrical battery, or the like. That is, when the battery has the shape and appearance as described above, the battery can be referred to as a “coin-type” secondary battery, for example.

Hereinafter, the manufacture method of the present application will be described in further detail according to an embodiment. Hereinafter, a case where the facing portion 50A is formed by facing the end faces 51A and 52A in a unifacial form and extending in one direction is taken as an example. The term “end face in a unifacial form” used in the present description refers to an end face formed of a single plane in a broad sense, and refers to an end face not formed of two or more continuous planes extending in different directions without having a bending point in a narrow sense.

For example, as the above possible mode, the facing portion 50A can be formed by overlapping the end face 51A of the cup-shaped exterior member 51 and the end face 52A of the lid-shaped exterior member 52 each other along the thickness direction. In other words, the facing portion 50A can be formed by making the end face 51A of the cup-shaped exterior member 51 and the end face 52A of the lid-shaped exterior member 52 overlap each other along the thickness direction. The “thickness direction” is a direction along the thickness of an exterior member, and means, for example, a direction perpendicular to a surface forming the exterior member. By taking such a mode, the end face 52A of the lid-shaped exterior member 52 and the end face 51A of the cup-shaped exterior member 51 overlap each other in the thickness direction. Since the end faces overlap each other in the thickness direction, the cup-shaped and lid-shaped exterior members hardly move in the thickness direction. Therefore, after the lid-shaped exterior member 51 is provided such that this member covers the opening of the cup-shaped exterior member 52 and until the laser beam L is applied, the lid-shaped exterior member 52 is hardly displaced in the thickness direction from the prescribed position and the welded portion 20 is easily formed at the prescribed position.

As a specific mode, the end faces 51A and 52A, which are components of the end parts of the exterior members, each may have an inclined form. In such a case, the end face 52A of the lid-shaped exterior member 52 and the end face 51A of the cup-shaped exterior member 51 are brought into contact with each other on each one face in contrast with a case where each of the end faces is formed of two faces like a tapered shape or the like. Therefore, a force such as gravity can be more suitably applied downward from the end face 52A of the lid-shaped exterior member 52 to the end face 51A of the cup-shaped exterior member 51, and generation of a gap between the end faces 51A and 52A can be more suitably inhibited.

In an embodiment, in a sectional view, the end parts of the exterior members have side faces opposite from each other (namely, the inner side face 51Xa and the outer side face 51Xb) and end faces linking the side faces, and the end faces can have an inclined form (see FIG. 2). Specifically, the end parts of the exterior members have side faces opposite from each other and substantially planar (namely, the inner side face 51Xa and the outer side face 51Xb), and inclined planes 51B and 52B linking the side faces.

In a broad sense, the term “inclined plane” used in the present description means a face having such a shape that the thickness of the end part forming the opening of the cup-shaped exterior member 51 or the lid-shaped exterior member 52 decreases from the bottom (namely, the main face side) toward the opening side in a sectional view. In a narrow sense, the term “inclined plane” used in the present specification refers to a face in which at least a part of the outer side face 51Xb of the end part of the cup-shaped exterior member 51 and at least a part of the inner side face 52Xa of the end part of the lid-shaped exterior member 52 are sloped.

In an embodiment, before the application of the laser beam L, the inclined planes 51B and 52B linking the side faces opposite from each other and substantially planar (the inner side face 51Xa and the outer side face 51Xb) are made to face each other to form the facing portion 50A. As a result, it is possible to position the inclined plane 51B, which is a component of the end part of the lid-shaped exterior member 51, right above the inclined plane 52B, which is a component of the end part of the cup-shaped exterior member 52. As a result, a force such as gravity can be applied in a substantially vertically downward direction from the inclined plane 52B of the lid-shaped exterior member 52 to the inclined plane 51B of the cup-shaped exterior member 51. As a result, it is possible to more suitably inhibit generation of a gap between the inclined planes 51B and 52B, which are components of the end parts of both the exterior members, and it is possible to more suitably bring both the inclined planes 51B and 52B into facing contact with each other. Therefore, it is possible to more conveniently secure the sealing property of the facing portion 50A of the cup-shaped exterior member 51 and the lid-shaped exterior member 52.

In an embodiment, as illustrated in FIG. 2, the inclined plane 51B of the end part of the lid-shaped exterior member 51 is positioned immediately above the inclined plane 52B of the end part of the cup-shaped exterior member 52. Therefore, when the thicknesses of the cup-shaped exterior member 51 and the lid-shaped exterior member 52, in particular, the thickness of at least the lid-shaped exterior member 52, are relatively increased, the weight of the lid-shaped exterior member 52 increases by the increase in the thickness, so that the force acting substantially vertically downward due to gravity or the like also increases. As a result, the gap between the inclined planes 51B and 52B can be further reduced, and the inclined planes 51B and 52B can be more effectively brought into contact with each other. Furthermore, it can also be expected that the strength of the exterior body constituted by both the exterior members 51 and 52 is improved by relatively increasing the thicknesses of the exterior members.

When viewed in a sectional view as illustrated in FIG. 2, when the end faces of the cup-shaped exterior member and the lid-shaped exterior member form an inclined form, the inner side face 51Xa of the cup-shaped exterior member and the inner side face 52Xa of the lid-shaped exterior member may be on the same straight line or on the same plane, and the outer side face 51Xb of the cup-shaped exterior member and the outer side face 52Xb of the lid-shaped exterior member may be on the same straight line or on the same plane. By taking such a form, the cup-shaped exterior member 51 and the lid-shaped exterior member 52 having substantially the same thickness can be used, so that the balance of the strength of the entire exterior body 50 composed of the cup-shaped and lid-shaped exterior members is further improved.

As illustrated in FIG. 2, the inclination angle θ formed between the inclined plane 51B and the inner side face 51Xa of the cup-shaped exterior member 51 in a sectional view is preferably 10 degrees or more and 70 degrees or less, more preferably 20 degrees or more and 60 degrees or less, and still more preferably 30 degrees or more and 50 degrees or less, for example, 45 degrees from the viewpoint of the insertion accuracy of the lid-shaped exterior member 52 into the opening of the cup-shaped exterior member 51. Similarly, the inclination angle formed between the inclined plane 52B and the outer side face 52Xb of the lid-shaped exterior member 52 is preferably 10 degrees or more and 70 degrees or less, more preferably 20 degrees or more and 60 degrees or less, and still more preferably 30 degrees or more and 50 degrees or less, for example, 45 degrees from the viewpoint of the insertion accuracy of the lid-shaped exterior member 51 into the opening of the cup-shaped exterior member 52. The inclination angle can vary depending on the wall thickness of the can and the lid, the insertion accuracy, and the allowable length of the inclined portion, but within the above range, the insertion accuracy of the lid-shaped exterior member 51 into the opening of the cup-shaped exterior member 52 can be improved.

Although not particularly limited, the inclined planes 51B and 52B of the end parts of the cup-shaped and lid-shaped exterior members 51 and 52 can be formed by shearing such as chamfering. In an embodiment, the cup-shaped and lid-shaped exterior members 51 and 52 can be manufactured by subjecting an exterior plate having a flat plate structure to drawing processing. An exterior member produced by drawing is superior in strength to a lid-shaped exterior member having a conventional flat plate structure due to its structure. In addition, as illustrated in FIG. 4, the exterior body 50 composed of the cup-shaped and lid-shaped exterior members manufactured by drawing has an r shape in which an edge 50a of the exterior body is rounded. Therefore, the appearance can be made to have a smoother shape than the edge 50a′ of the exterior body of a conventional secondary battery as illustrated in FIG. 12, and it is easy to prevent leaving due to an external impact.

The inclined plane 51B of the cup-shaped exterior member 51 is formed on the outer side face 51Xb side, and the inclined plane 52B of the lid-shaped exterior member 52 is formed on the inner side face 52Xa side. However, the present application is not limited thereto, and the inclined plane 51B may be formed on the inner side face 51Xa side, and the inclined plane 52B may be formed on the inner side face 52Xa side. The secondary battery obtained through the formation also has the features described exemplarily with reference to FIG. 2 and the effects exhibited thereby.

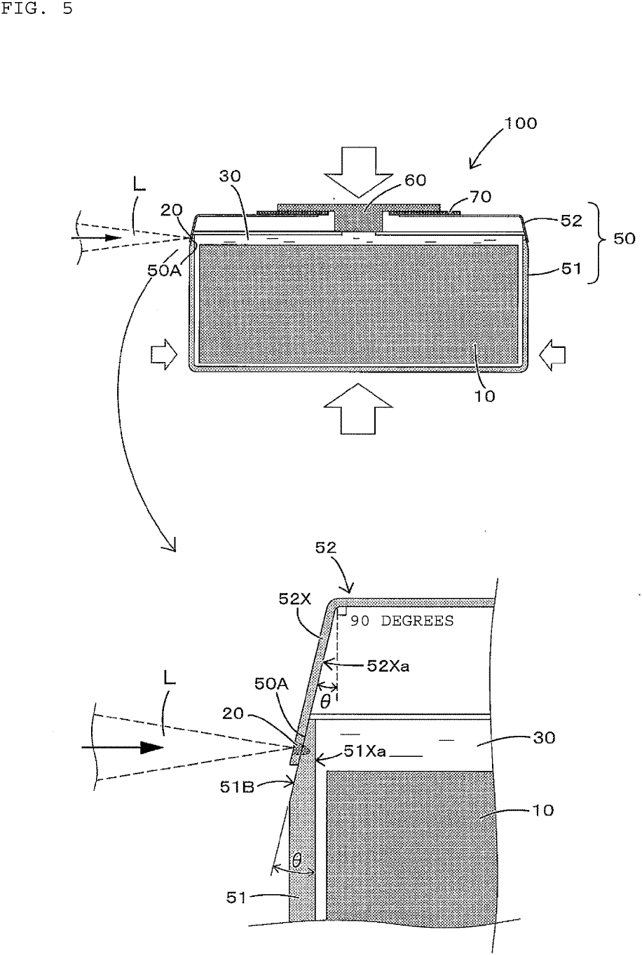

In another embodiment, the side face 52X itself of the end part of one of the cup-shaped exterior member 51 and the lid-shaped exterior member 52 may have an inclined form, and the other exterior member may have an end face in an inclined form at the end part (see FIG. 5). Specifically, in an embodiment, the side face itself of the end part of one exterior member is just required to have an inclined form, and the other exterior member is just required to have a structure in which the end part has side faces opposite from each other and substantially planar and an inclined plane linking the side faces.

FIG. 5 is a schematic sectional view illustrating a step of forming a welded portion 20 using a lid-shaped exterior member 52 having a side face in an inclined form at the end part and a cup-shaped exterior member 52 having an end face in an inclined form at the end part. Hereinafter, a case where the side face itself of the end part of the lid-shaped exterior member 52 has an inclined form will be taken as an example and described with reference to FIG. 5. In one example, as illustrated in FIG. 5, the inclined plane 51B is formed at the end part positioned at the opening of the cup-shaped exterior member 51, and the side face 52X in an inclined form of the lid-shaped exterior member 52 is positioned on the inclined plane 51B. Specifically, the side face of the cup-shaped exterior member 51 extends substantially perpendicularly from the main face of the cup-shaped exterior member 51, and the inclined plane is provided at the end part of the cup-shaped exterior member 51. The side face 52X of the lid-shaped exterior member is not perpendicular to the planar main face of the lid-shaped exterior member 52, and has an inclined structure in which the opening size of the lid-shaped exterior member 52 increases. The side face 52X of the lid-shaped exterior member is inclined at an inclination angle θ with respect to a vertical line extending from the main face of the lid-shaped exterior member 52. The inclination may be achieved by molding the exterior member by drawing or the like. In addition, the inclination angle θ may be adjusted at the time of drawing the exterior member.

Also in such a form, the side face 52X in an inclined form of the lid-shaped exterior member 52 can be positioned on the inclined plane 51B of the end part of the cup-shaped exterior member 51 before irradiation with the laser beam L. As a result, a force such as gravity can be applied in a downward direction from the side face 52X in an inclined form of the lid-shaped exterior member 52 to the inclined plane 51B of the cup-shaped exterior member 51. As a result, it is possible to inhibit generation of a gap between the inclined plane 51B and the side face 52X in the inclined form, which are components of the end parts of both the exterior members, and it is possible to bring the inclined plane 51B and the side face 52X in the inclined form into facing contact with each other. Therefore, it is possible to conveniently secure the sealing property of the facing portion 50A of the cup-shaped exterior member 51 and the lid-shaped exterior member 52. In the above description, a mode in which the end part of the cup-shaped exterior member 51 has an inclined plane, and the side face itself of the lid-shaped exterior member 52 has an inclined form has been described, but the above description is not limited to the above mode. For example, also when the side face itself of the end part of the cup-shaped exterior member 51 has an inclined form and the end part of the lid-shaped exterior member has an inclined plane, it is possible to have the same featured as those of the above mode and the effects exhibited thereby.

When side faces opposite from each other and substantially planar (for example, the inner side face 51Xa and the outer side face 51Xb) and an inclined plane linking the side faces are to be provided at the end part of an exterior member, the inclined plane can be formed by performing shearing such as chamfering on the end part of the exterior member. When the end part of the exterior member having a relatively small thickness is subjected to shearing such as chamfering, the end part of the exterior member is shaved by shearing, so that the thickness of the inclined plane to be formed has a very small thickness. Formation of such an inclined plane having a very small thickness can be technically more difficult. According to an embodiment, as one of the two exterior members, one whose side face itself has an inclined form is used. As described above, the exterior member in which the side face itself has an inclined form can be achieved by forming the exterior member by drawing or the like. That is, shearing or the like may not be used for forming the exterior member in which the side face itself has an inclined form. Therefore, also when the exterior member is relatively thin, the exterior member in which the side face itself has an inclined form can be relatively easily obtained. Therefore, as compared with an embodiment illustrated in FIG. 2, it is possible to reduce the thickness (wall thickness) of one of the exterior members in addition to inhibiting the generation of a gap in the facing portion 50A of the end parts of both the exterior members. Therefore, it is possible to conveniently secure the sealing property in the facing portion 50A of the end parts of the two exterior members and to reduce the thickness and size of a resulting secondary battery 100.

Also in the mode illustrated in FIG. 5 as in the mode illustrated in FIG. 2, the inclination angle θ formed between the inclined plane 51B and the inner side face 51Xa of the cup-shaped exterior member 51 in a sectional view is preferably 10 degrees or more and 70 degrees or less, more preferably 20 degrees or more and 60 degrees or less, and still more preferably 30 degrees or more and 50 degrees or less, for example, 45 degrees from the viewpoint of the insertion accuracy of the lid-shaped exterior member 52 into the opening of the cup-shaped exterior member 51. At the same time, from the viewpoint of suitable facing contact between the inclined plane 51B of the cup-shaped exterior member 51 and the side face 52X in the inclined form of the lid-shaped exterior member 52, the side face 52X of the lid-shaped exterior member may have an inclined structure in which the side face 52X is not perpendicular to the planar main face of the lid-shaped exterior member 52 but is opened from the planar main face by an angle of 90 + θ degrees.

In still another embodiment, both the side face 51X of the end part of the cup-shaped exterior member 51 and the side face 52X of the end part of the lid-shaped exterior member 52 may have an inclined form (see FIG. 6).

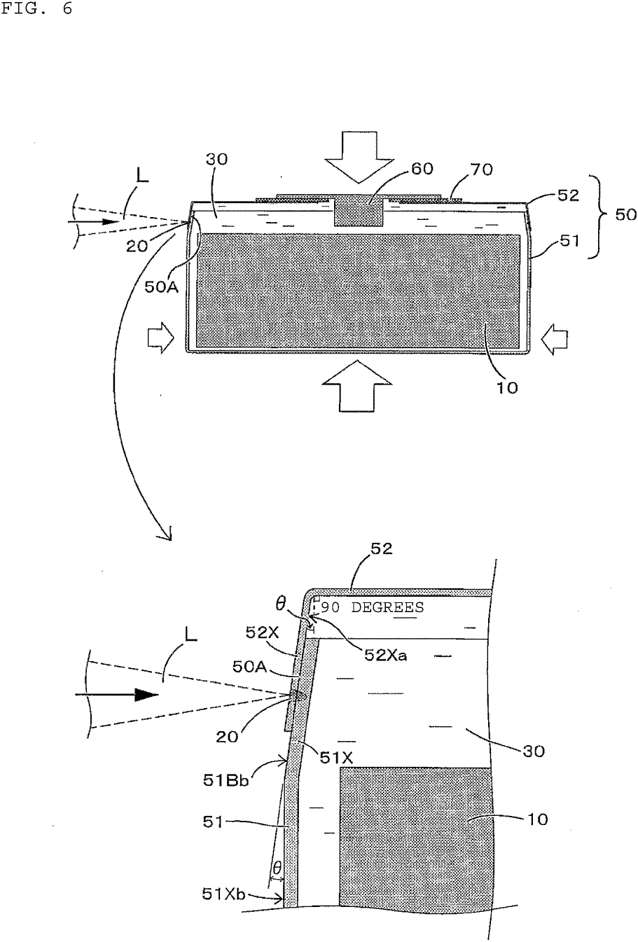

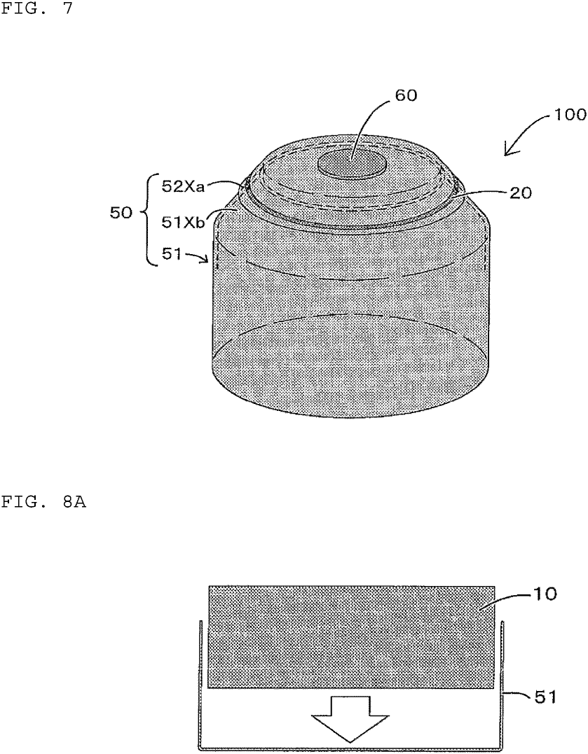

FIG. 6 is a schematic sectional view illustrating a step of forming a welded portion using a lid-shaped exterior member having a side face in an inclined form at the end part and a cup-shaped exterior member having a side face in an inclined form at the end part. FIG. 7 is a schematic perspective view illustrating a secondary battery obtained through the step of forming a welded portion illustrated in FIG. 6. As illustrated in FIG. 6, in an embodiment, both the side faces 51X and 52X of the end parts of both the exterior members 51 and 52 have a structure having an inclined form.

The side face 52X of the lid-shaped exterior member illustrated in FIG. 6 is inclined outward with respect to the main face of the lid-shaped exterior member, similarly to the mode illustrated in FIG. 5. Further, a part of the side face 51X of the cup-shaped exterior member is inclined inward with respect to the main face of the cup-shaped exterior member. Specifically, the end part of the side face 51X of the cup-shaped exterior member is inclined inward such that the opening diameter of the cup-shaped exterior member 51 becomes smaller with respect to the extending direction of the side face of the cup-shaped exterior member. The side face 51X of the cup-shaped exterior member is inclined at an inclination angle θ with respect to a vertical line extending from the main face of the cup-shaped exterior member 51. The side face 52X of the lid-shaped exterior member is inclined at an inclination angle θ with respect to a vertical line extending from the main face of the lid-shaped exterior member 52. The inclination may be achieved by molding the exterior member by drawing or the like. In addition, the inclination angle θ may be adjusted at the time of drawing the exterior member.

Also in such a form, the side face 52X in the inclined form of the lid-shaped exterior member 52 can be positioned on the side face 51X in the inclined form of the end part of the cup-shaped exterior member 51 before irradiation with the laser beam L. As a result, a force such as gravity can be applied in a downward direction from the side face 52X in the inclined form of the lid-shaped exterior member 52 to the side face 51X in the inclined form of the cup-shaped exterior member 51. As a result, it is possible to inhibit generation of a gap between the side faces 51X and 52X each in the inclined form, which are components of the end parts of both the exterior members, and it is possible to bring the side faces 51X and 52X each in the inclined form into facing contact with each other. Therefore, it is possible to conveniently secure the sealing property of the facing portion 50A of the cup-shaped exterior member 51 and the lid-shaped exterior member 52.

According to an embodiment, both side faces of the two exterior members have an inclined form. The exterior member in which the side face itself has an inclined form may be achieved by forming the exterior member by drawing or the like as described above. That is, shearing or the like may not be used for forming the exterior member in which the side face itself has an inclined form. Therefore, also when the exterior member is relatively thin, the exterior member in which the side face itself has an inclined form can be relatively easily obtained. Therefore, as compared with an embodiment illustrated in FIGS. 2 and 5, it is possible to reduce the thickness (wall thickness) of both the exterior members in addition to inhibiting the generation of a gap in the facing portion 50A of the end parts of both the exterior members. Therefore, it is possible to conveniently secure the sealing property in the facing portion 50A of the end parts of the two exterior members and to further reduce the thickness and size of a resulting secondary battery 100 (see FIG. 7).

Also in the mode illustrated in FIG. 6 as in the mode illustrated in FIG. 5, the inclination angle θ of the cup-shaped exterior member 51 in a sectional view is preferably 10 degrees or more and 70 degrees or less, more preferably 20 degrees or more and 60 degrees or less, and still more preferably 30 degrees or more and 50 degrees or less, for example, 45 degrees from the viewpoint of the insertion accuracy of the lid-shaped exterior member 52 into the opening of the cup-shaped exterior member 51. At the same time, from the viewpoint of suitable facing contact between the cup-shaped exterior member 51 and the lid-shaped exterior member 52, the side face 52X of the lid-shaped exterior member may have an inclined structure in which the side face 52X is not perpendicular to the planar main face of the lid-shaped exterior member 52 but is opened from the planar main face by an angle of 90 + θ degrees.

In addition, since the thickness of both the exterior members can be reduced, when a welded portion 20 is formed using a laser beam L, the welded portion 20 can be formed with a reduced irradiation output of the laser beam and a narrowed irradiation range. Therefore, since the irradiation heat energy of the laser beam L can be further reduced, thermal damage to the electrode assembly 10 due to the irradiation heat of the laser beam can be further reduced.

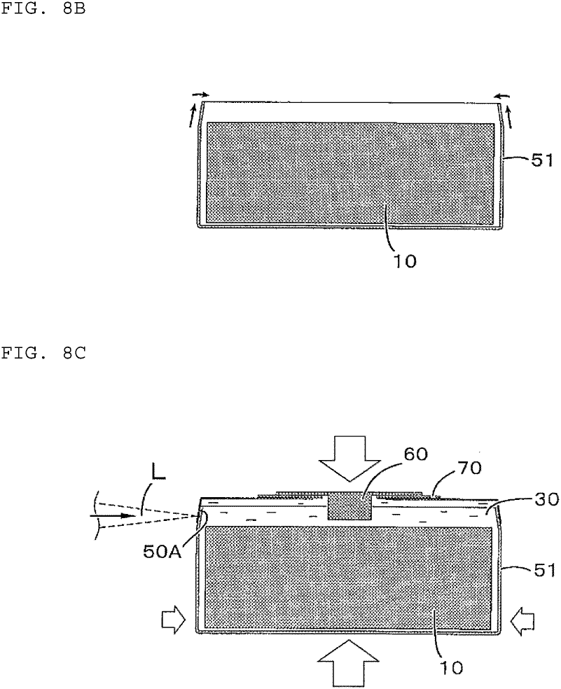

In addition, a method for manufacturing the secondary battery 100 illustrated in FIG. 7 which is obtained according to an embodiment will be described below with reference to FIGS. 8A to 8C.

FIG. 8A is a schematic sectional view illustrating a step of installing an electrode assembly inside a cup-shaped exterior member in a method for manufacturing a secondary battery according to another embodiment. FIG. 8B is a schematic sectional view illustrating a step of drawing the end part of the cup-shaped exterior member in a method for manufacturing a secondary battery according to another embodiment. FIG. 8C is a schematic sectional view illustrating a step of forming a welded portion by the application of a laser beam in a method for manufacturing a secondary battery according to another embodiment.

Hereinafter, a method for manufacturing a secondary battery according to an embodiment will be described with reference to drawings. The method for manufacturing a secondary battery according to an embodiment includes:
(i) installing an electrode assembly 10 inside a cup-shaped exterior member 51 (see FIG. 8A);
(ii) performing drawing on a part of an end part of an opening of the cup-shaped exterior member 51 (see FIG. 8B);
(iii) providing a lid-shaped exterior member such that this member covers an opening of the cup-shaped exterior member 51 with the cup-shaped exterior member 51 having been filled with an electrolytic solution 30;and
(iv) applying a laser beam L to a portion 50A where the cup-shaped exterior member 51 and the lid-shaped exterior member 52 face each other to form a welded portion (see FIG. 8C) .

Since the method for manufacturing the secondary battery has already been described with reference to FIGS. 1A to 1C, only characteristic steps as compared with an embodiment illustrated in FIGS. 1 to 1C will be described. Specifically, an embodiment is characterized by the step (ii). Hereinafter, the step (ii) will be described in more detail with reference to FIG. 8B.

As illustrated in FIG. 8B, after the electrode assembly 10 is installed inside the cup-shaped exterior member 51, drawing is applied on the end part located at the opening of the cup-shaped exterior member 51, and an inclined shape is provided on the side face of the cup-shaped exterior member 51. Specifically, the side faces in an inclined form of the end part of the cup-shaped exterior member 51 and the end part of the lid-shaped exterior member 52 are formed by locally bending parts of the planar extending surfaces of both the exterior members by drawing. In other words, the side face of the cup-shaped exterior member 51 is provided with a taper angle at a portion to be brought close to the side face of the lid-shaped exterior member 52.

Although one or more embodiments have been described herein, the present application is not limited thereto.

In the above description, the case where the “end faces” of the end parts of both the exterior members 51 and 52 form an inclined face form has been described, but an embodiment is not limited thereto. For example, the present application can also be realized when the “end faces” extend in the horizontal direction.

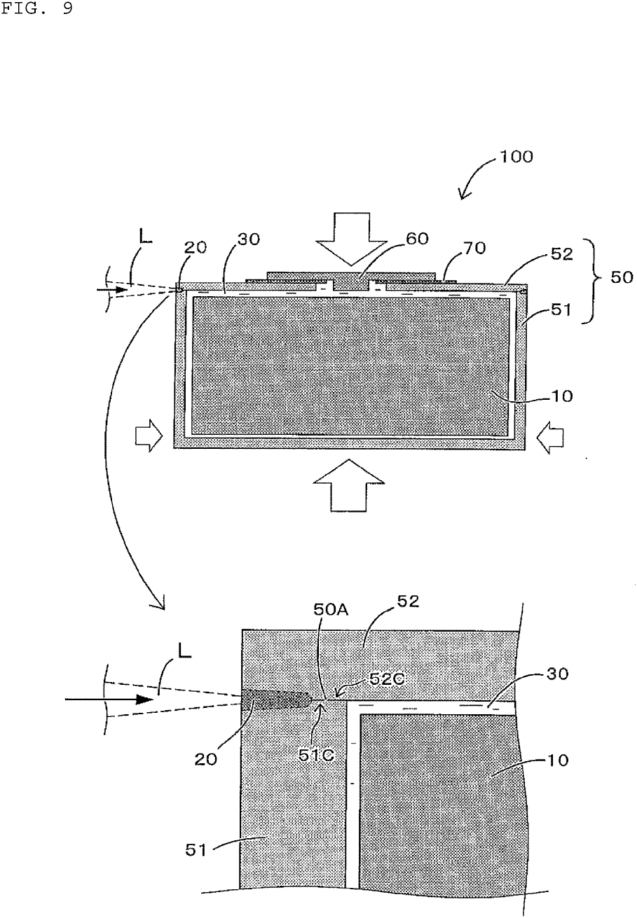

Specifically, as illustrated in FIG. 9, in the step of providing the lid-shaped exterior member 51 such that this member covers the opening of the cup-shaped exterior member 52, the horizontal face 51C and the horizontal face 52C of the end parts located at the respective openings of the cup-shaped exterior member 51 and the lid-shaped exterior member 52 are brought close to each other. Even in such a case, it is possible to inhibit generation of a gap between the horizontal faces 51C and 52C of the end parts of both the exterior members 51 and 52. Furthermore, the method in the mode illustrated in FIG. 9 can be said to be a more convenient manufacturing method because drawing is not required for forming the lid-shaped exterior member 52, and drawing is not required for forming the cup-shaped exterior member 51.

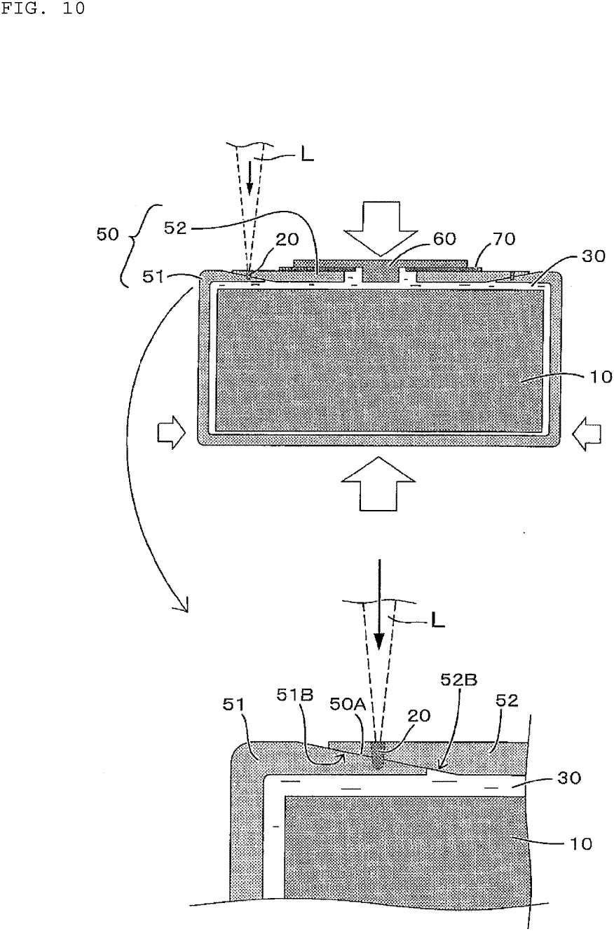

In accordance with the manufacturing method according to an embodiment, the welded portion 20 can be formed on the side face of the exterior body 50 as illustrated in FIGS. 3 and 4. However, the present application is not limited thereto, and the following can also be taken as long as it is possible to inhibit generation of a gap between the end faces of the end parts of both the exterior members 51 and 52 according to an embodiment. Specifically, as illustrated in FIG. 10, the end part of the opening of the cup-shaped exterior member 51 may be provided not on the side face but on the upper face side, and an inclined plane of the end part of the opening of the cup-shaped exterior member 52 may be provided to directly face the end part. In the mode illustrated in FIG. 10, since the opening of the cup-shaped exterior member 51 is located on the upper face side, the electrolytic solution 30 filled in the cup-shaped exterior member 51 can be made difficult to leak to the outside during the manufacturing process.

The secondary battery according to an embodiment of the present application can be used in various fields in which electricity storage is assumed. Although the followings are merely examples, the secondary battery of the present application can be used in the fields of electricity, information and communication fields where electricity and electronic devices and the like are used (for example, electricity and electronic device fields or mobile device fields including small electronic devices such as mobile phones, smart phones, laptop computers, digital cameras, activity meters, arm computers, electronic papers, RFID tags, card type electronic money, and smart watches), domestic and small industrial applications (for example, the fields such as electric tools, golf carts, domestic robots, caregiving robots, and industrial robots), large industrial applications (for example, the fields such as forklifts, elevators, and harbor cranes), transportation system fields (for example, the fields such as hybrid vehicles, electric vehicles, buses, trains, electric assisted bicycles, and two-wheeled electric vehicles), electric power system applications (for example, the fields such as various power generation systems, load conditioners, smart grids, and home-installation type power storage systems), medical care applications (the medical care instrument fields such as earphone acoustic aids), medicinal applications (the fields such as dosing management systems), IoT fields, and space and deep sea applications (for example, the fields such as spacecraft and research submarines).

### DESCRIPTION OF REFERENCE SYMBOLS

1: Positive electrode
2: Negative electrode
3: Separator
5: Electrode configuration layer
10, 10′: Electrode assembly
20, 20′: Welded portion
30: Electrolytic solution
41: Positive electrode current collection tab
42: Negative electrode current collection tab
50: Exterior body
50a, 50a′: Edge of exterior body
51, 51′: Cup-shaped exterior member
51A: End face
51B: Inclined plane
51C: Horizontal plane
51X: Side face
51Xa: Inner side face
51Xb: Outer side face
52, 52′: Lid-shaped exterior member
52A: End face
52B: Inclined plane
52C: Horizontal plane
52X: Side face
52Xa: Inner side face
52Xb: Outer side face
53′: Facing portion of cup-shaped and lid-shaped exterior members
54′: Stepped portion of cup-shaped exterior member
54a′, 54c′: Substantially vertical plane of stepped portion
54b′: Substantially horizontal plane of stepped portion
55′: Stepped portion of lid-shaped exterior member
55a′, 54c′: Substantially vertical plane of stepped portion
55b′: Substantially horizontal plane of stepped portion
60: External output terminal
70: Insulating member
90: Sputter
100, 100′: Secondary battery
L, L′ : Laser beam

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for manufacturing a secondary battery, the method comprising:
installing an electrode assembly inside a cup-shaped exterior member,
providing a lid-shaped exterior member such that the lid-shaped exterior member covers an opening of the cup-shaped exterior member, and
forming a welded portion by applying a laser beam to a facing portion where the cup-shaped exterior member and the lid-shaped exterior member face each other,
wherein the facing portion is formed by positioning an end face of an end part of one of the cup-shaped exterior member and the lid-shaped exterior member on an end face of an end part of the other exterior member, and each of the end faces is in a non-stepped form.

2. The method for manufacturing a secondary battery according to claim 1, wherein the facing portion is formed by facing the end faces each having a unifacial shape extending in one direction.

3. The method for manufacturing a secondary battery according to claim 1, wherein the facing portion is formed by overlapping the end face of the cup-shaped exterior member and the end face of the lid-shaped exterior member each other along a thickness direction.

4. The method for manufacturing a secondary battery according to claim 1, wherein the end faces each have an inclined form.

5. The method for manufacturing a secondary battery according to claim 4, wherein the end face in the inclined form is, in a sectional view, an end face of an end part of at least one of the cup-shaped exterior member and the lid-shaped exterior member, and the end face is a face formed to link side faces opposite from each other of the exterior member.

6. The method for manufacturing a secondary battery according to claim 5, wherein when the end faces of the cup-shaped exterior member and the lid-shaped exterior member each form an inclined form, an inner side face of the cup-shaped exterior member and an inner side face of the lid-shaped exterior member are on the same straight line, and an outer side face of the cup-shaped exterior member and an outer side face of the lid-shaped exterior member are on the same straight line.

7. The method for manufacturing a secondary battery according to claim 4, wherein the end face in the inclined form is a side face of the end part of at least one of the cup-shaped exterior member and the lid-shaped exterior member in a sectional view, and the side face has an inclined form.

8. The method for manufacturing a secondary battery according to claim 7, wherein the side face in the inclined form of at least one of the end part of the cup-shaped exterior member and the end part of the lid-shaped exterior member is formed by locally bending a part of a planar exterior member by drawing.

9. The method for manufacturing a secondary battery according to claim 1, wherein the facing portion is formed by facing a side face of the cup-shaped exterior member and a side face of the lid-shaped exterior member.

10. The method for manufacturing a secondary battery according to claim 1, wherein the end faces of the end parts are end faces extending in a non-vertical direction.

11. The method for manufacturing a secondary battery according to claim 1, wherein the secondary battery is a coin-type battery.

12. The method for manufacturing a secondary battery according to claim 1, wherein an electrode assembly comprising a positive electrode and a negative electrode that are capable of occluding and releasing lithium ions is used as the electrode assembly.
